(19) United States
(12) Patent Application Publication
(10) Pub. No.: US 2023/0046458 A1
(43) Pub. Date: Feb. 16, 2023

(54) SYSTEM FOR HARVESTING THE TOP PORTIONS OF PLANTS AND RELATED AGRICULTURAL HARVESTER

(71) Applicant: CNH Industrial America LLC, New Holland, PA (US)

(72) Inventor: Jason R. Coppinger, Davenport, IA (US)

(73) Assignee: CNH Industrial America LLC

(21) Appl. No.: 17/400,564

(22) Filed: Aug. 12, 2021

(51) Int. Cl. A01D 61/00; A01D 47/00; A01D 41/06; A01D 41/14

(52) U.S. Cl. CPC A01D 61/00; A01D 47/00; A01D 41/06; A01D 41/14

(57) ABSTRACT

An agricultural harvester includes an annular housing having an arcuate cross-section such that the annular housing defines a toroidal chamber therein.

Furthermore, the agricultural harvester includes a blade supported below the annular housing in a vertical direction, with the blade configured to sever top portions of plants from stalks of the plants. Additionally, the agricultural harvester includes a crop flow director positioned above the blade in the vertical direction, with the crop flow director configured to direct the severed top portions into the toroidal chamber. Moreover, the agricultural harvester includes an elevator assembly supported relative to the annular housing. In addition, the agricultural harvester includes a fan assembly configured to generate a flow of air through the annular housing to convey the severed top portions from the toroidal chamber to the elevator assembly.

### FIELD OF THE INVENTION

The present disclosure generally relates to agricultural harvesters and, more particularly, to a system for harvesting the tops portions of plants growing within a field and a related agricultural harvester.

### BACKGROUND OF THE INVENTION

A combine harvester is a type of agricultural harvester used to harvest grain crops, such as wheat, oats, rye, barley, corn, soybeans, etc. More specifically, a combine harvester typically includes a detachable header or other harvesting implement. The header, in turn, cuts and collects the crop from the field for delivery to a crop processing system of the combine harvester. The crop processing system then performs various processing operations (e.g., threshing, separating, etc.) on the received harvested crop. Thereafter, the processed harvested crop may be delivered to a crop tank for storage.

Grain crops are typically harvested at single time during the growing season. In the respect, the header of a combine harvesters cuts the stalks of the crops being harvested just above the field surface, leaving behind stubble. This stubble will then be broken and incorporated into the soil during a subsequent tillage operation. However, it is beneficial for the different portions of some plants to be harvested at different times. For example, it is generally desirable to harvest the flowers of a hemp plant before harvesting the stalks. Combine harvesters and other types of agricultural harvesters are generally unable to do this. Moreover, the crop processing system of a combine harvester separates the grain from the chaff by rubbing or beating the harvester grain crop. Such rubbing will damage hemp flowers and other delicate top portions of certain plants.

### SUMMARY OF THE INVENTION

Aspects and advantages of the technology will be set forth in part in the following description, or may be obvious from the description, or may be learned through practice of the technology.

In one aspect, the present subject matter is directed to an agricultural harvester. The agricultural harvester includes an annular housing having an arcuate cross-section such that the annular housing defines a toroidal chamber therein. Furthermore, the agricultural harvester includes a blade supported below the annular housing in a vertical direction, with the blade configured to sever top portions of plants from stalks of the plants. Additionally, the agricultural harvester includes a crop flow director positioned above the blade in the vertical direction, with the crop flow director configured to direct the severed top portions into the toroidal chamber. Moreover, the agricultural harvester includes an elevator assembly supported relative to the annular housing. In addition, the agricultural harvester includes a fan assembly configured to generate a flow of air through the toroidal chamber to convey the severed top portions from the toroidal chamber to the elevator assembly.

In another aspect, the present subject matter is directed to a system for harvesting top portions of plants. The system includes an annular housing having an arcuate cross-section such that the annular housing defines a toroidal chamber therein. Furthermore, the system includes a blade supported below the annular housing in a vertical direction, with the blade configured to sever the top portions of the plants from stalks of the plants. Additionally, the system includes a crop flow director positioned above the blade in the vertical direction, with the crop flow director configured to direct the severed top portions into the toroidal chamber. Moreover, the system includes an elevator assembly supported relative to the annular housing. In addition, the system includes a fan assembly configured to generate a flow of air through the toroidal chamber to convey the severed top portions from the toroidal chamber to the elevator assembly.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a perspective view of one embodiment of a system for harvesting the top portions of plants in accordance with aspects of the present subject matter;

FIG. 3 illustrates a cross-section view of the system shown in FIG. 3 taken generally about Line 3-3, particularly illustrating the components of a crop cutting assembly of the system;

FIG. 4 illustrates a perspective view of one embodiment of an annular housing in accordance with aspects of the present subject matter;

FIG. 5 illustrates a perspective view of one embodiment of a crop flow director in accordance with aspects of the present subject matter; and

FIG. 6 illustrates a perspective view of another embodiment of the crop flow director in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system for harvesting the top portions of plants and a related agricultural harvester. Specifically, in several embodiments, the system includes an annular housing having an arcuate cross-section such that the annular housing defines a toroidal chamber therein. Furthermore, the system includes a blade supported below the annular housing. In this respect, the blade is configured to sever or cut the top portions of the plants growing within a field from their stalks. For example, in one embodiment, the blade may sever the top portions by rotating relative to the annular housing. Additionally, the system includes a crop flow director positioned above the blade. In some embodiments, the crop flow director may be positioned within a central passage defined by the annular housing. Thus, the crop flow director configured to direct the severed top portions of the plants into the toroidal chamber. Moreover, the system includes an elevator assembly supported relative to the annular housing. In addition, the system includes a fan assembly configured to generate a flow of air through the annular housing to convey the severed top portions from the toroidal chamber to the elevator assembly. The elevator assembly may, in turn, deliver severed top portions to a crop tank for storage.

The disclosed system and agricultural harvester allow for the harvesting of certain crops (e.g., hemp) that cannot be harvested using conventional harvesters (e.g., a combine harvester). More specifically, the disclosed system and harvester sever only the top portion of the plant (e.g., the hemp flowers), leaving behind the stalks for harvesting at a later time. Moreover, as described above, the disclosed system and harvester sever the top portions of the plants with the blade, direct the severed top portions into the toroidal chamber with the crop flow director, and convey to the elevators using a flow of air through the toroidal chamber for storage in a crop tank. As such, the disclosed system and harvester allow the top portions of the plants to be harvested and conveyed to the crop tank for storage therein without rubbing, beating, or other rough contact, thereby preventing damage to the top portions. For example, when harvesting hemp flowers, such delicate handling preserves the fragile crystalline surface chemicals used to produce cannabidiol (CBD) oil that are present on the flowers.

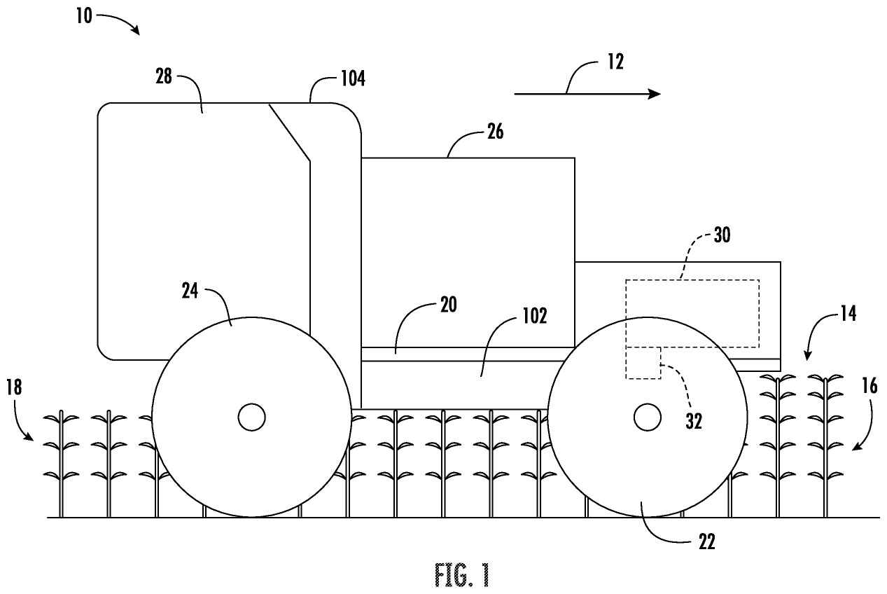

Referring now to the drawings, FIG. 1 illustrates a side view of an agricultural harvester 10. In general, the harvester 10 is configured to travel across a field in a forward direction of travel (indicated by arrow 12) to harvest top portions 14 of plants 16. In this respect, the harvester 10 leaves stalks 18 of the plants 16 standing within the field for harvesting at a later time (e.g., with a forage harvester or windrower). For example, in some embodiments, the harvester 10 may be configured to harvest the flowers of hemp plants, while leaving behind the stalks of the hemp plants for later harvesting. However, in alternative embodiments, the harvester 10 may be configured to harvest the top portions of any other suitable type of plant.

The harvester 10 may include a frame or chassis 20 configured to support and/or couple to various components of the harvester 10. For example, in several embodiments, the harvester 10 may include a pair of driven, front wheels 22 and a pair of steerable, rear wheels 24 coupled to the frame 20. As such, the wheels 22, 24 are configured to support the harvester 10 relative to the ground and move the harvester 10 in the forward direction of travel 12. In some embodiments, the wheels 22, 24 are sized such that the frame 20 is positioned above the top portions 14 of the plants 16. Furthermore, the harvester 10 may include an operator's cab 26, one or more crop cutting assemblies 102, an elevator assembly 104, and a crop tank 28 supported by the frame 22. In some embodiments, the crop cutting assembly(ies) 102 are positioned underneath or otherwise at the bottom of the harvester 10 to provide access to the top portions of the plants growing within the field. Additionally, the harvester 10 may include an engine 30 and a transmission 32 mounted on the frame 22. The transmission 32 may be operably coupled to the engine 30 and may provide variably adjusted gear ratios for transferring engine power to the wheels 22, e.g., via a chain drive assembly(ies) (not shown).

As mentioned above, the agricultural harvester 10 is configured to harvest the top portions 14 of the plants 16, while leaving the stalks 18 standing in the field. More specifically, as the harvester 10 travels across the field in the direction of travel 12, the crop cutting assembly(ies) 102 cuts or severs the top portions 14 of the plants 16 (e.g., the flowers of hemp plants) from their stalks 18 and directs the severed top portions 14 to the elevator assembly 104. Thereafter, the elevator assembly 104 conveys the severed top portions 14 to the crop tank 28 for storage.

Additionally, in some embodiments, the position of the crop cutting assembly(ies) 102 may be adjustable relative to the ground along a vertical direction (indicated by arrow 34). In this respect, the operator may raise or lower the crop cutting assembly(ies) 102 relative to the ground to adjust the cutting height of the assembly(ies) 102. As such, the harvester 10 can harvest the top portions of plants having differing heights. In one embodiment, the height of the frame 20 (and, thus, the operator's cab 26, the crop cutting assembly(ies) 102, the elevator assembly 104, and the crop tank 28 supported thereon) may collectively be adjustable relative to the ground. In other embodiments, the crop cutting assembly(ies) 102 may be adjustable relative to the frame 20 in the vertical direction 34, with the height of the frame 20 relative to the ground being fixed. Thus, in such embodiments, by adjusting the position of the crop cutting assembly(ies) 102 relative to the frame 20, the height of the crop cutting assembly(ies) 102 relative to the ground can be adjusted. However, in alternative embodiments, the position of the crop cutting assembly(ies) 102 relative to the ground may be fixed.

It should be further appreciated that the configuration of the agricultural harvester 10 described above and shown in FIG. 1 is provided only to place the present subject matter in an exemplary field of use. Thus, it should be appreciated that the present subject matter may be readily adaptable to any manner of harvester configuration.

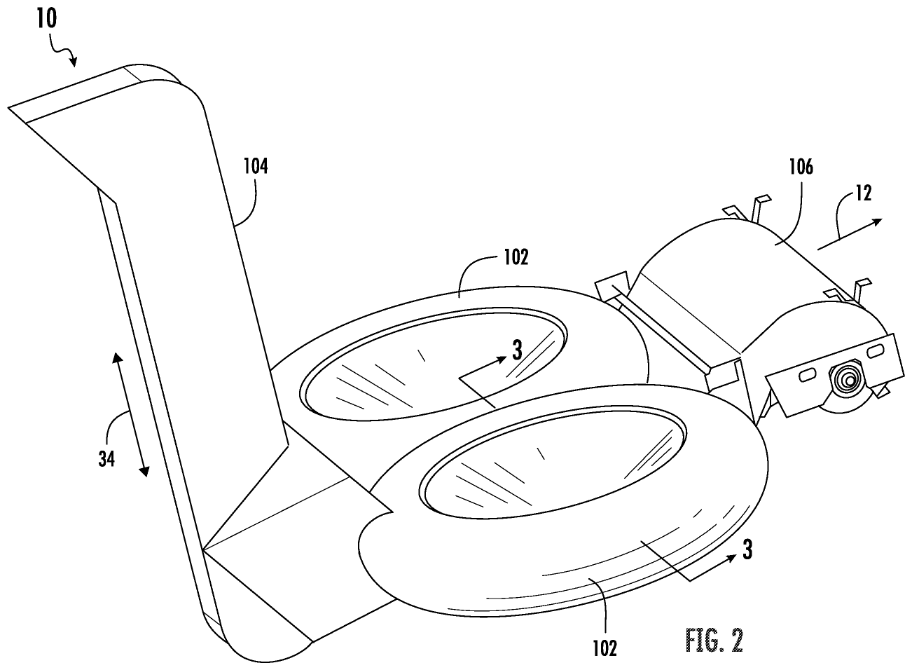

Referring now to FIG. 2, a schematic view of one embodiment of a system 100 for harvesting the top portions of plants is illustrated in accordance with aspects of the present subject matter. In general, the system 100 will be described herein with reference to the agricultural harvester 10 described above with reference to FIG. 1. However, it should be appreciated by those of ordinary skill in the art that the disclosed system 100 may generally be utilized with agricultural harvesters having any other suitable harvester configuration.

In several embodiments, the system 100 includes one or more crop cutting assemblies 102. As indicated above, each crop cutting assembly 102 is configured to cut or sever the top portions of the plants (e.g., the flowers of hemp plants) from their stalks and direct the severed top portions to the elevator assembly 104. In the illustrated embodiment, the system 100 includes a pair of crop cutting assemblies 102 positioned side by side such that the assemblies 102 are aligned with each other in the direction of travel 12. However, in alternative embodiments, the system 100 may include any other suitable number of crop cutting assemblies 102. For example, in one embodiment, the system 100 may include only a single crop cutting assembly 102.

Furthermore, the system 100 includes the elevator assembly 104. As indicated above, the elevator assembly 104 is configured to convey the severed top portions of the plants from the crop cutting assembly(ies) 102 to the crop tank 28 (FIG. 1) of the harvester 10. For example, in some embodiments, the elevator assembly 104 may generally move the severed top portions in the vertical direction 34 such that the severed top portions are delivered to the top end of the crop tank 28. In the illustrated embodiment, the elevator assembly 104 is positioned aft of the crop cutting assemblies 102 relative to the direction of travel 12. However, in alternative embodiments, the elevator assembly 104 may be positioned in any location relative to the crop cutting assembly(ies)102.

The elevator assembly 104 may have any suitable construction or configuration that allows the severed top portions of the plants to be conveyed from the cutting assembly(ies) 102 to the crop tank 28. For example, in one embodiment, the elevator assembly 104 may include a looped chain (not shown) and a plurality of paddles (not shown) attached to and evenly spaced along the chain. Each paddle may, in turn, be configured to hold a quantity of the severed top portions of the plants as the chain is driven in an endless loop, thereby conveying the top portions along the length of the elevator assembly 104.

Moreover, the system 100 includes a fan assembly 106. In general, the fan assembly 106 is configured to generate a flow of air through the crop cutting assembly(ies) 102 and into the elevator assembly 104. This air flow, in turn, conveys the severed top portions of the plants from the crop cutting assembly(ies) 102 to the elevator assembly 104. In the illustrated embodiment, fan assembly 106 is positioned forward of the crop cutting assembly(ies) 102 relative to the direction of travel 12. However, in alternative embodiments, the fan assembly 106 may be positioned at any other suitable location relative to the crop cutting assembly(ies) 102. In addition, the fan assembly 106 may be driven in any suitable manner, such as via a belt coupled to an accessory drive (not shown) of the engine 30, a hydraulic motor, an electric motor, and/or the like.

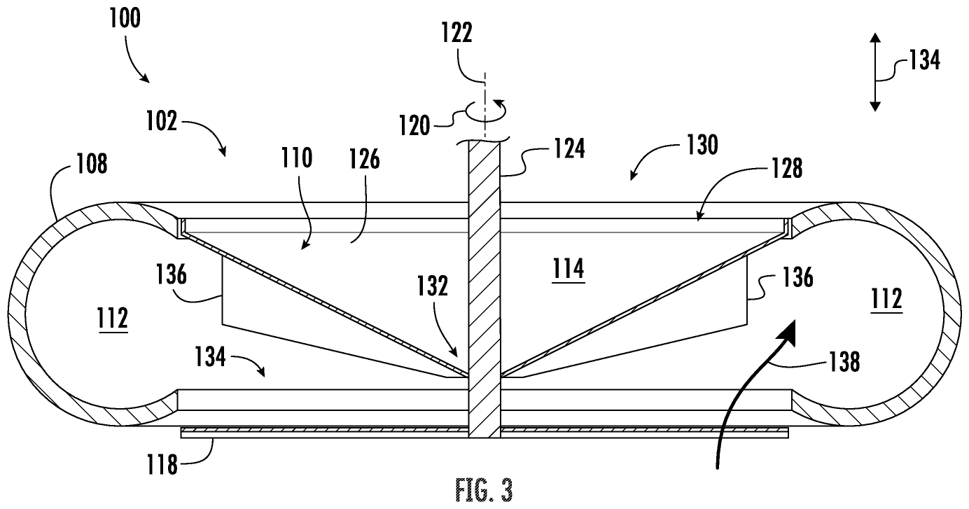

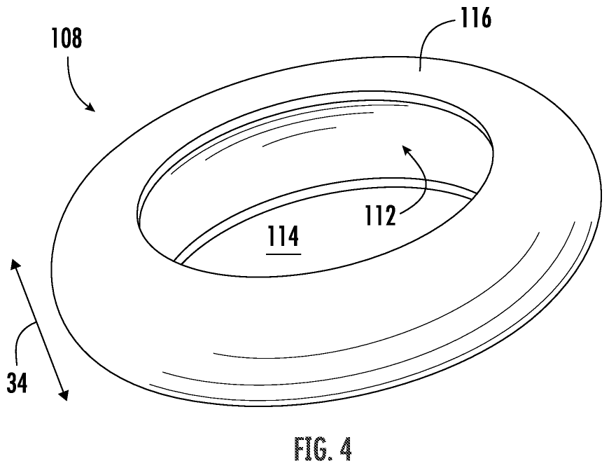

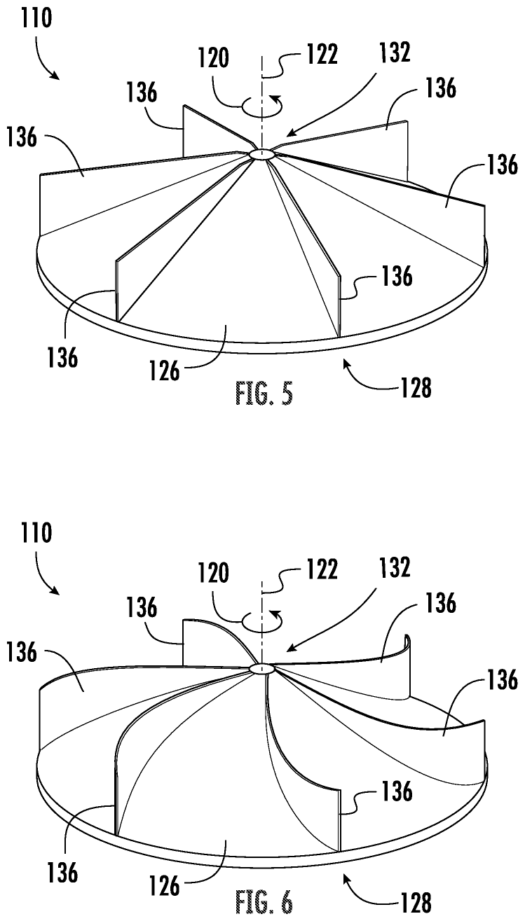

FIGS. 3-6 illustrates varying views a crop cutting assembly 102 and its components. More specifically, FIG. 3 illustrates s a cross-section view of the crop cutting assembly 102 taken generally about Line 3-3 in FIG. 2. Furthermore, FIG. 4 illustrates a perspective view of one embodiment of an annular housing 108 of the crop cutting assembly 102. Additionally, FIG. 5 illustrates a perspective view of one embodiment of a crop flow director 110 of the crop cutting assembly 102. Moreover, FIG. 6 illustrates a perspective view of another embodiment of the annular housing 108 of the crop cutting assembly 102.

As shown in FIGS. 3 and 4, the crop cutting assembly 102 includes the annular housing 108 supported relative to the elevator assembly 104. More specifically, the annular housing 108 has an arcuate cross-section (e.g., a C-shaped cross-section) such that the annular housing 108 defines a toroidal chamber 112 therein. Moreover, the annular housing 108 defines a central passage 114 extending through its center. For example, in one embodiment, the annular housing 108 includes a C-shaped wall 116 defining the toroidal chamber 112 and central passage 114. In such an embodiment, the annular housing 108 is shaped similarly to a tire. Thus, flow (e.g., of air and the severed top portions of the plants) is permitted between the central passage 114 and the toroidal chamber 112. As will be described below, the crop flow director 110 may be positioned within the central passage 114 such that the crop flow director 110 directs the severed top portions of the plants into the toroidal chamber 112. In this respect, the fan assembly 106 (FIG. 2) generates a flow of air through the toroidal chamber 112 that conveys the severed top portions from the toroidal chamber 112 to the elevator assembly 104.

Referring particularly to FIG. 3, the crop cutting assembly 102 also includes a blade 118. In general, the blade 118 is configured to sever or cut the top portions of the plants growing within the field across which the harvester 10 is traveling from their stalks. More specifically, the blade 118 is supported below the annular housing 108 in the vertical direction 34. For example, as shown, in some embodiments, the blade 118 is rotatably supported below the central passage 114 defined by the annular housing 108. In this respect, the blade 118 is configured to rotate relative the annular housing 108 to sever the top portions of the plants from their stalks as the harvester 10 travels across the field in the direction of travel 12. Moreover, the blade 118 may be curved or otherwise formed such that the severed top portions of the plants are directed upward along the vertical direction 34 and into the central passage 114. Additionally, as mentioned above, in some embodiments, the position of the annular housing 108 relative to the ground in the vertical direction 34 may be adjustable. In such embodiments, the cutting height of the blade 118 may be adjusted to accommodate plants of differing sizes.

Moreover, the crop cutting assembly 102 includes the crop flow director 110. In general, the crop flow director 110 is configured to direct the top portions of the plants severed from their stalks by the blade 118 radially outward and into the toroidal chamber 112 defined by the annular housing 108. As shown, the crop flow director 110 is supported above the blade 118 in the vertical direction 34 such that the crop flow director 110 is positioned within the central passage 114 defined by the annular housing 108. In several embodiments, the crop flow director 110 may be configured to rotate relative to the annular housing 108 to direct the severed top portions of the plants into the toroidal chamber 112. For example, in some embodiments, the crop flow director 110 and the blade 118 may be configured to rotate (e.g., as indicated by arrow 120 in FIG. 3) about a common axis 122. Specifically, in one embodiment, the crop flow director 110 and the blade 118 may both be coupled to a shaft 124 that is rotatably supported relative to the annular housing 108. In such an embodiment, the shaft 124 may be rotationally driven (e.g., via the engine 30) such that the crop flow director 110 and the blade 118 rotate at the same speed. In other embodiments, the crop flow director 110 and the blade 118 may be rotated at different speeds (e.g., by using a gearbox (not shown) positioned between the crop flow director 110 and the blade 118). Thus, the blade 118 may be rotated faster than the crop flow director 110. However, in alternative embodiments, the crop flow director 110 and the blade 118 may be configured to rotate about different axes.

Referring now to FIGS. 3, 5, and 6, the crop flow director 110 may have any suitable configuration that allows the crop flow director 110 to direct the severed top portions of the plants into the toroidal chamber 112. For example, in several embodiments, the crop flow director 110 may include a frustoconical wall 126. As shown, the frustoconical wall 126 is positioned within the central passage 114 defined by the annular housing 108 such that the frustoconical wall 126 narrows as the frustoconical wall 126 extends downward along the vertical direction 34. That is, a base 128 of the frustoconical wall 126 is positioned at a top end 130 of the annular housing 108 and a truncated end 132 of the frustoconical wall 126 is positioned at a bottom end 134 of the annular housing 108. Moreover, in some embodiments, the common axis 122 and/or shaft 124 may extend through the center of the frustoconical wall 126.

In addition, the crop flow director 110 may also include a plurality of circumferentially spaced apart fins 136 coupled to the frustoconical wall 126. The fins 136 are, in turn, configured to direct the top portions of the plants severed from their stalks by the blade 118 into the toroidal chamber 112. As such, the fins 136 may be spaced apart from each other around the circumference of the frustoconical wall 126. Furthermore, the fins 126 may extend outward from the frustoconical wall 126 (e.g., on the side of the wall 126 facing the blade 118). In some embodiments, as shown in FIGS. 3 and 5, the fins 136 may extend in a linear or otherwise straight manner between the truncated end 132 of the frustoconical wall 126 and the base 128 of the frustoconical wall 126. Alternatively, as shown in FIG. 6, the fins 136 may be curved or otherwise extend in a curved manner from between the truncated end 132 of the frustoconical wall 126 and the base 128 of the frustoconical wall 126. As will be described below, the fins 136 direct the severed top portions of the plants into the toroidal chamber 112 (e.g., as indicated by arrow 138 in FIG. 3) as the crop flow director 110 is rotated about the axis 122. The curved fins 136 may direct the severed top portions of the plants into the toroidal chamber more gently than the straight fins 136.

As mentioned above, in some embodiments, the system 100 (or the associated harvester 10) may include two crop cutting assemblies 102 positioned side by side. In such embodiments, the system 100 may include two annular housings 108, two blades 118, and two crop flow directors 110. Each annular housing 108 may, in turn, define a toroidal chamber 112 such that the system 100 includes two toroidal chambers 112. Moreover, in such embodiments, the system 100 may include a single fan assembly 106 and a single elevator assembly 104. In this respect, the fan assembly 106 generates a flow of air through both toroidal chambers 112, thereby conveying the top portions of the plants harvested by both crop cutting assemblies 102 to the elevator assembly 104 for eventual delivery to the crop tank 28.

As mentioned above, the system 100 is configured to harvest the top portions of plants growing within a field. More specifically, as the harvester 10 travels across the field in the direction of travel 12, the blade(s) 118 and the crop flow director(s) 110 may rotate relative to the annular housing(s) 108. In this respect, the rotation of the blade(s) 118 severs the top portions of the plants (e.g., the top portions 14 of the plants 16 in FIG. 1) from their stalks and directs the top portions upward in the vertical direction 34 into the corresponding central passage(s) 114. As the crop flow director(s) 110 rotate, the fins 136 direct the severed top portions of the plants radially outward into the corresponding toroidal chamber(s) 112. The flow(s) of air through the toroidal chamber(s) 112 generated by the fan assembly 106 then conveys the severed top portions from the toroidal chamber(s) 112 to the base of the elevator assembly 104. Thereafter, the elevator assembly 104 transports the severed top portions of the plants into the crop tank 28 for storage. Thus, the stalks (e.g., the stalks 18 in FIG. 1) remaining within the field after the harvesting the top portions of the plants can be harvested at later time (e.g., with a forage harvester or a windrower).

Furthermore, as mentioned above, the system 100 and related harvester 10 may be used to harvest the flowers of hemp plants. More specifically, the flowers of a hemp plant can be used to produce CBD oil, while the stalks of the hemp plant can be used in the industrial materials market. In general, it is desirable to harvest the flowers of the hemp plants earlier than the stalks of the hemp plants. This ensures that the hemp flowers are harvested while at higher moisture state and before seeds are produced, thereby preserving the fragile crystalline chemicals on the surface of the flowers (sometimes referred to as kief) used to make CBD oil. In this respect, the disclosed system 100 and harvester 10 allow the flowers of the hemp plants to be harvested, while leaving the stalks of the hemp plants standing within the field for harvesting at a later time (e.g., with a forage harvester or windrower). Moreover, the hemp flowers are delicate and can be easy damaged when handled. As such, by directing the severed hemp flowers into the toroidal chamber(s) 112 with the crop flow director 110 and using a flow(s) of air through the toroidal chamber(s) 112 to convey the flowers to the elevator assembly 104, the hemp flowers are transported from the blade(s) 118 to the elevator assembly 104 without any rubbing, beating, or other rough contact. Thus, the disclosed system 100 and harvester 10 provide for gentle and minimal handling of the hemp flowers, thereby preventing or reducing damage of to the flowers (particularly to the kief).

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural harvester, comprising:
an annular housing having an arcuate cross-section such that the annular housing defines a toroidal chamber therein;
a blade supported below the annular housing in a vertical direction, the blade configured to sever top portions of plants from stalks of the plants;
a crop flow director positioned above the blade in the vertical direction, the crop flow director configured to direct the severed top portions into the toroidal chamber;
an elevator assembly supported relative to the annular housing; and
a fan assembly configured to generate a flow of air through the toroidal chamber to convey the severed top portions from the toroidal chamber to the elevator assembly.

2. The agricultural harvester of claim 1, wherein the crop flow director is configured to rotate relative to the annular housing to direct the severed top portions into the toroidal chamber.

3. The agricultural harvester of claim 2, wherein the blade is configured to rotate relative to the annular housing to sever the top portions of the plants from the stalks of the plants.

4. The agricultural harvester of claim 3, wherein the crop flow director and the blade are rotatable about a common axis.

5. The agricultural harvester of claim 4, further comprising:
a shaft rotatably supported relative to the annular housing, wherein the crop flow director and the blade are coupled to the shaft.

6. The agricultural harvester of claim 1, wherein the crop flow director is positioned within a central passage defined by the annular housing.

7. The agricultural harvester of claim 1, wherein the crop flow director comprises a frustoconical wall and a plurality of circumferentially spaced apart fins extending outward from the frustoconical wall, the plurality of fins configured to direct the severed top portions of the plants into the toroidal chamber.

8. The agricultural harvester of claim 7, wherein each fin of the plurality of fins is curved.

9. The agricultural harvester of claim 1, wherein the annular housing corresponds to a first annular housing, the toroidal chamber corresponds to a first toroidal chamber, the blade corresponds to a first blade, and the crop flow director corresponds to a first crop flow director, the agricultural harvester further comprising:
a second annular housing having an arcuate cross-section such that the annular housing defines a second toroidal chamber therein;
a second blade supported below the second annular housing in the vertical direction, the second blade configured to sever the top portions of the plants from the stalks of the plants; and
a second crop flow director positioned above the second blade in the vertical direction, the second crop flow director configured to direct the severed top portions into the second toroidal chamber,
wherein the fan assembly is further configured to generate a flow of air through the second toroidal chamber to convey the severed top portions from the second toroidal chamber to the elevator assembly.

10. The agricultural harvester of claim 1, wherein the fan assembly is positioned forward of the annular housing relative to a direction of travel of the agricultural harvester and the elevator is positioned aft of the annular housing relative to the direction of travel.

11. The agricultural harvester of claim 1, wherein a position of the annular housing relative to a ground surface is adjustable in the vertical direction.

12. The agricultural harvester of claim 1, further comprising:
a frame coupled to the annular housing, the elevator assembly, and the fan assembly;
a plurality of wheels coupled to the frame; and
a cab supported on the frame.

13. A system for harvesting top portions of plants, the system comprising:
an annular housing having an arcuate cross-section such that the annular housing defines a toroidal chamber therein;
a blade supported below the annular housing in a vertical direction, the blade configured to sever the top portions of the plants from stalks of the plants;
a crop flow director positioned above the blade in the vertical direction, the crop flow director configured to direct the severed top portions into the toroidal chamber;
an elevator assembly supported relative to the annular housing; and
a fan assembly configured to generate a flow of air through the toroidal chamber to convey the severed top portions from the toroidal chamber to the elevator assembly.

14. The system of claim 13, wherein the crop flow director is configured to rotate relative to the annular housing to direct the severed top portions into the toroidal chamber.

15. The system of claim 14, wherein the blade is configured to rotate relative to the annular housing to sever the top portions of the plants from the stalks of the plants.

16. The system of claim 15, wherein the crop flow director and the blade are rotatable about a common axis.

17. The system of claim 16, further comprising:
a shaft rotatably supported relative to the annular housing, wherein the crop flow director and the blade are coupled to the shaft.

18. The system of claim 13, wherein the crop flow director is positioned within a central passage defined by the annular housing.

19. The system of claim 1, wherein the crop flow director comprises a frustoconical wall and a plurality of circumferentially spaced apart fins extending outward from the frustoconical wall, the plurality of fins configured to direct the severed top portions of the plants into the toroidal chamber.

20. The system of claim 19, wherein each fin of the plurality of fins is curved.
